(19) United States
(12) Patent Application Publication
(10) Pub. No.: US 2025/0372789 A1
(43) Pub. Date: Dec. 4, 2025

(54) Battery box

(71) Applicant: Nanning FuLian FuGui Precision Industrial Co., Ltd., Nanning (CN)

(72) Inventor: WU-JEN LO, New Taipei (TW)

(21) Appl. No.: 18/676,672

(22) Filed: May 29, 2024

(51) Int. Cl. H01M 50/244; H01M 50/242; H01M 50/264; H01M 50/291

(52) U.S. Cl. CPC H01M 50/244; H01M 50/264; H01M 50/291; H01M 50/242

(57) ABSTRACT

A battery box includes a housing, a partition element, a first restriction element, and a driving element. The housing includes a bottom plate, and a first pivoting base disposed on the bottom plate. The partition element is in the housing, and disposed on the bottom plate. The first restriction element is pivoted on first pivoting base, and a first battery groove is formed between the first restriction element and the partition element. The driving element is disposed on the first restriction element. When the driving element is moved in the opening direction, the first restriction element is rotated relative to the bottom plate, so as to increasing the distance between the top of the first restriction element and the top of the partition element.

### FIELD

The subject matter herein generally relates to battery boxes.

### BACKGROUND

Batteries are used to be installed in a mobile device to provide power to the mobile device. In order to facilitate battery replacement, a battery box is usually set up in the mobile device to allow batteries with fixed specifications to be installed in the battery groove of the battery box. In addition, the battery groove in the battery box will also match the size of the battery to prevent the battery from shifting in the battery groove and thereby separating from the electrodes of the battery box.

However, the battery in the battery box may be swollen due to factors such as service life or defects. In particular, rechargeable batteries are swollen due to excessive charging and discharging. Users usually install the battery when the battery is new or fully charged, and then remove it after a period of time when the battery is out of power or has insufficient power. At this time, the battery may have swollen and become stuck in the battery groove, making it difficult to remove and replace it, resulting in the inability to provide power to the mobile device.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a perspective view of a battery box in accordance with an embodiment of the present disclosure.

FIG. 2 is an exploded view of the battery box shown in FIG. 1.

FIG. 3 is a partial perspective view of the battery box shown in FIG. 1.

FIG. 4 is a perspective view of the battery box in an opening state.

FIG. 5 is a partial perspective view of the battery box in a releasing state.

FIG. 6 is a cross-sectional view of the battery box in the releasing state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In the present disclosure, swollen batteries can be easily taken out from the battery box by changing the size of the battery groove in the battery box.

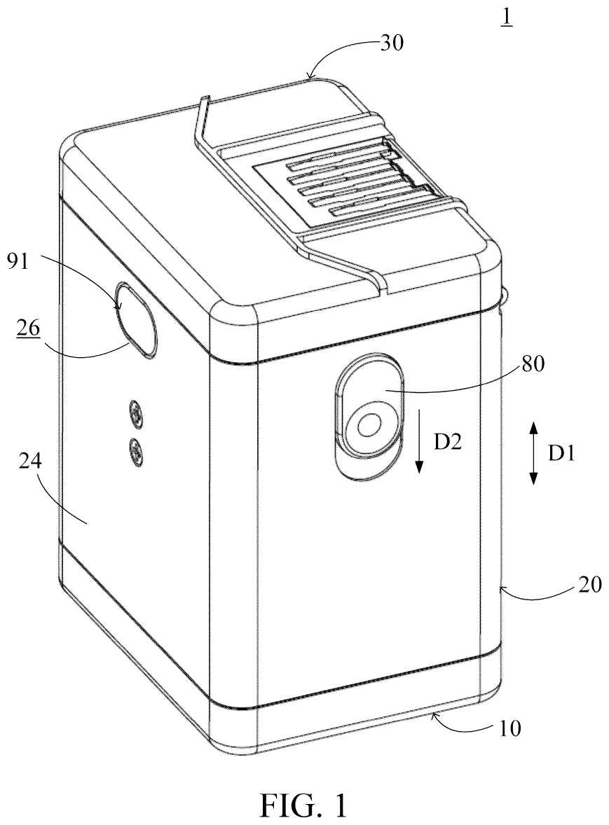

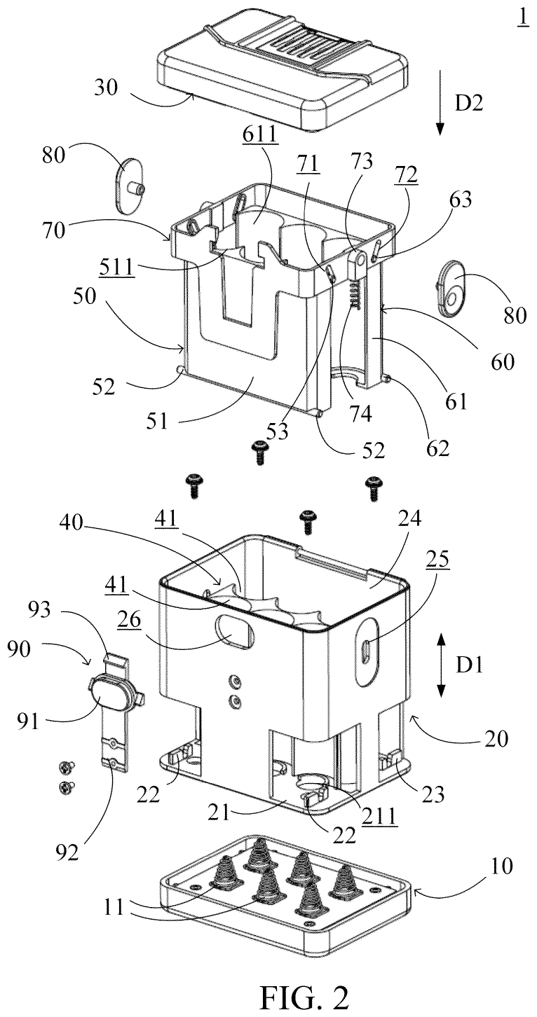

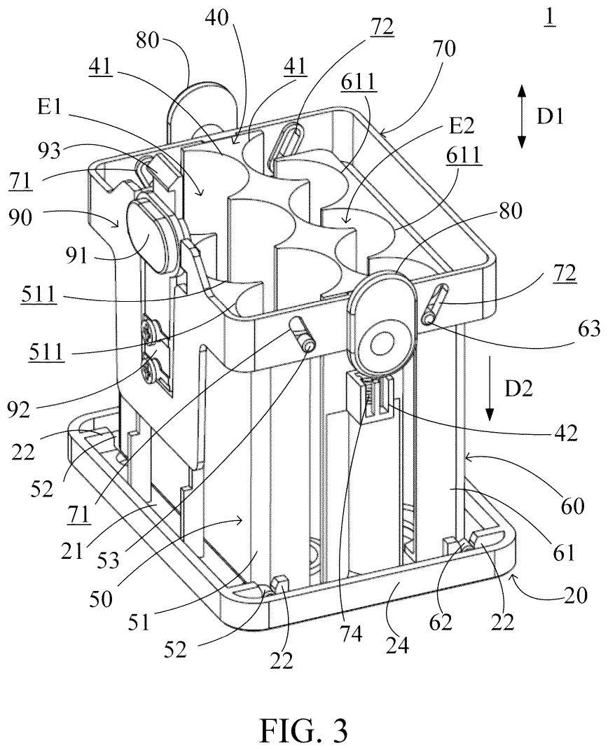

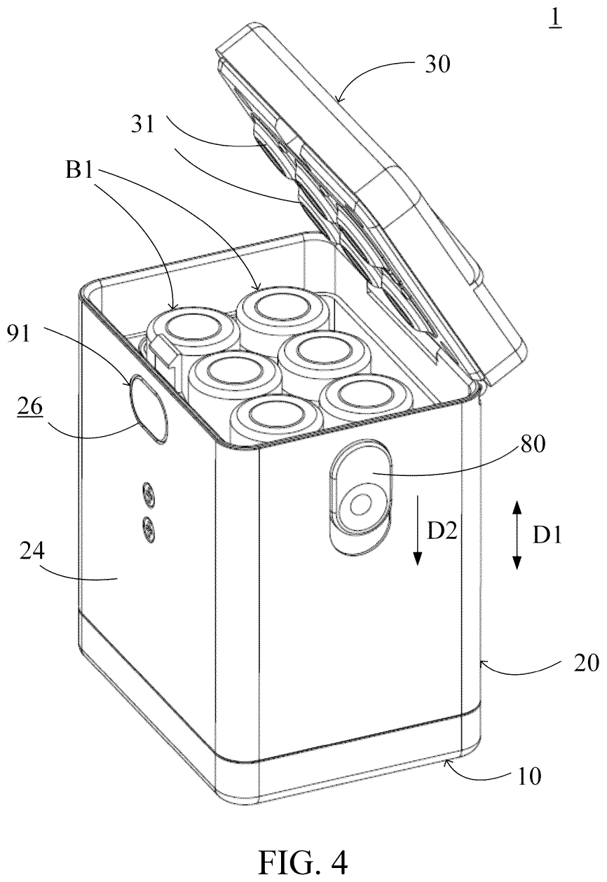

FIG. 1 is a perspective view of a battery box 1 in accordance with an embodiment of the present disclosure. FIG. 2 is an exploded view of the battery box 1 shown in FIG. 1. FIG. 3 is a partial perspective view of the battery box 1 shown in FIG. 1. FIG. 4 is a perspective view of the battery box 1 in an opening state. The battery box 1 can accommodate batteries B1 as shown in FIG. 4. The batteries B1 may be dry batteries or cylindrical batteries. The battery box 1 can be electrically connected to an electronic device, and supply power to the electronic device. The battery box 1 includes a base 10, a housing 20, a cover 30, a partition element 40, a first restriction element 50, a second restriction element 60, a driving element 70, two releasing buttons 80, and an opening button 90. The base 10 may be a plate structure. The base 10 includes first elastic electrodes 11 arranged on the upper surface of the base 10. In the embodiment, the first elastic electrodes 11 is used to contact the batteries B1, and the first elastic electrodes 11 may be springs.

The housing 20 is affixed to the base 10. For the purpose of clarity, some parts of the housing 20 are hidden in FIG. 2 and FIG. 3, and some elements, such as the cover 30 and the base 10, are not shown in FIG. 3. The housing 20 includes a bottom plate 21, two first pivoting bases 22, two second pivoting bases 23, and a side wall 24. The bottom plate 21, the first pivoting base 22, the second pivoting base 23, and/or the side wall 24 can be made of the same materials, such as plastic. Moreover, the bottom plate 21, the first pivoting base 22, the second pivoting base 23, and/or the side wall 24 can be an integrally formed structure. The bottom plate 21 extends perpendicular to an extension direction D1. The base 10 is affixed to the bottom plate 21. The bottom plate 21 includes electrode holes 211. When the bottom plate 21 is affixed to the base 10, the first elastic electrodes 11 extend into the housing 20 via the electrode holes 211 of the bottom plate 21.

The first pivoting bases 22 and the second pivoting bases 23 are disposed on the bottom plate 21, and located in the housing 20. The side wall 24 extends perpendicular to the bottom plate 21. In the embodiment, the side wall 24 extends in the extension direction D1. The side wall 24 may be a ring structure, surrounding the partition element 40, the first restriction element 50, the second restriction element 60, and the driving element 70.

The cover 30 is pivoted on the top of the side wall 24 of the housing 20. The cover 30 includes the second elastic electrodes 31 (shown in FIG. 4) arranged on the lower surface of the cover 30.

The partition element 40 is in the housing 20, and is disposed on the bottom plate 21. The partition element 40 extends in the extension direction D1, and between the first restriction element 50 and the second restriction element 60. The partition element 40 includes main receiving grooves 41 extends in the extension direction D1. The main receiving grooves 41 are located on opposite sides of the partition element 40. The batteries B1 can be placed in the main receiving grooves 41.

The first restriction element 50 is in the housing 20, and pivoted on the first pivoting bases 22. The first battery groove E1 shown in FIG. 3 are formed between the first restriction element 50 and the partition element 40. The batteries B1 can be placed in the first battery groove E1, and contact the first elastic electrodes 11 and the second elastic electrodes 31. In the embodiment, the first restriction element 50 includes a first restriction body 51 and two first rotation shafts 52. The first restriction body 51 is in the housing 20, and includes first receiving grooves 511. The batteries B1 can be placed in the first receiving grooves 511. The first receiving grooves 511 extend in the extension direction D1, and face the main receiving grooves 41. In the embodiment, the first battery groove E1 is formed between the main receiving grooves 41 and the first receiving grooves 511. Two first rotation shafts 52 are located at opposite sides of the first restriction body 51. The first rotation shafts 52 are disposed on the bottom of the first restriction body 51, and pivoted on the first pivoting bases 22.

The second restriction element 60 is in the housing 20, and pivoted on the second pivoting base 23. The second battery groove E2 shown in FIG. 3 is formed between the second restriction element 60 and the partition element 40, and the batteries B1 can be placed in the second battery groove E2, and contact the first elastic electrodes 11 and the second elastic electrodes 31. In the embodiment, the second restriction element 60 includes a second restriction body 61 and two second rotation shafts 62. The second restriction body 61 is in the housing 20, and includes second receiving grooves 611. The batteries B1 can be placed in the second receiving grooves 611. The second receiving grooves 611 extend in the extension direction D1, and face the main receiving grooves 41. In the embodiment, the second battery groove E2 is formed between the main receiving grooves 41 and the second receiving grooves 611. Two second rotation shafts 62 are located at opposite sides of the second restriction body 61. The second rotation shafts 62 are disposed on the bottom of the second restriction body 61, and pivoted on the second pivoting bases 23.

The driving element 70 is movably disposed on the first restriction element 50 and the second restriction element 60. In the embodiment, the driving element 70 surrounds the top of the first restriction element 50, the top of the second restriction element 60, and the top of the partition element 40. When the driving element 70 is moved in the opening direction D2, the first restriction element 50 and the second restriction element 60 are respectively rotated relatively to the bottom plate 21, thereby increasing the distance between the top of the first restriction element 50 and the top of the partition element 40, and increasing the distance between the top of the second restriction element 60 and the top of the partition element 40. In other words, the top of the first restriction element 50 and the top of the second restriction element 60 are moved in opposite directions.

In the embodiment, the driving element 70 further includes two first guiding grooves 71 and two second guiding grooves 72. The extension of the first guiding grooves 71 and the extension of the second guiding grooves 72 are inclined relative to the extension direction D1. The distance between the top end of the first guiding groove 71 and the top end of the second guiding groove 72 is greater than the distance between the bottom end of the first guiding groove 71 and the bottom end of the second guiding groove 72. The bottom end of the first guiding groove 71 is closer to the base 10 (or the bottom plate 21) than the top end of the first guiding groove 71. The bottom end of the second guiding groove 72 is closer to the base 10 (or the bottom plate 21) than the top end of second guiding groove 72.

The first restriction element 50 further includes first driving portions 53 in the first guiding grooves 71. The second restriction element 60 further includes second driving portions 63 in the second guiding grooves 72. When the driving element 70 is moved in the opening direction D2, the driving element 70 is moved toward the base 10 (or the bottom plate 21). The first driving portion 53 is moved from the bottom end of the first guiding groove 71 to the top end of the first guiding groove 71, and the second driving portion 63 is moved from the bottom end of the second guiding groove 72 to the top end of the second guiding groove 72. In the embodiment, the opening direction D2 is parallel to the extension direction D1. In other words, the extension of the first guiding groove 71 and the extension of the second guiding groove 72 are inclined relative to the opening direction D2.

Two releasing buttons 80 is movably disposed on the outer surface of the housing 20. The driving element 70 further includes two limitation blocks 73, which are located at opposite sides of the driving element 70. The releasing buttons 80 are connected to the limitation blocks 73 of the driving element 70 via the limitation holes 25 of the side wall 24 of the housing 20. In the embodiment, the limitation holes 25 extend in the extension direction D1 and/or the opening direction D2. Therefore, the limitation holes 25 restrict the releasing buttons 80 and the driving element 70 moving in the opening direction D2. The partition element 40 further includes two blocking portions 42, which are located at opposite sides of the partition element 40. The driving element 70 further includes elastic elements 74, which abut the blocking portions 42 and the limitation blocks 73. The elastic elements 74 are used to maintain the driving element 70 in an initial position.

The opening button 90 is disposed on the housing 20, and is used to lock the cover 30. The opening button 90 includes a button body 91, an elastic arm 92, and a hook 93. The button body 91 is in the housing 20, and exposed from the front opening 26 of the side wall 24 of the housing 20. The elastic arm 92 is connected to the button body 91, and one end of the elastic arm 92 is affixed to the side wall 24 of the housing 20. The hook 93 is connected to the button body 91, and is used to lock the cover 30. Moreover, in the embodiment, the driving element 70 includes a U-shaped area. The elastic arm 92 and the button body 91 are in the U-shaped area, thereby saving the utilization of the internal space of the housing 20. In the embodiment, when the opening button 90 is pressed, the cover 30 is released by the hook 93. At this time, the batteries B1 are pushed by the first elastic electrodes 11, so that the batteries B1 push the cover 30, and then the cover 30 is opened relative to the housing 20.

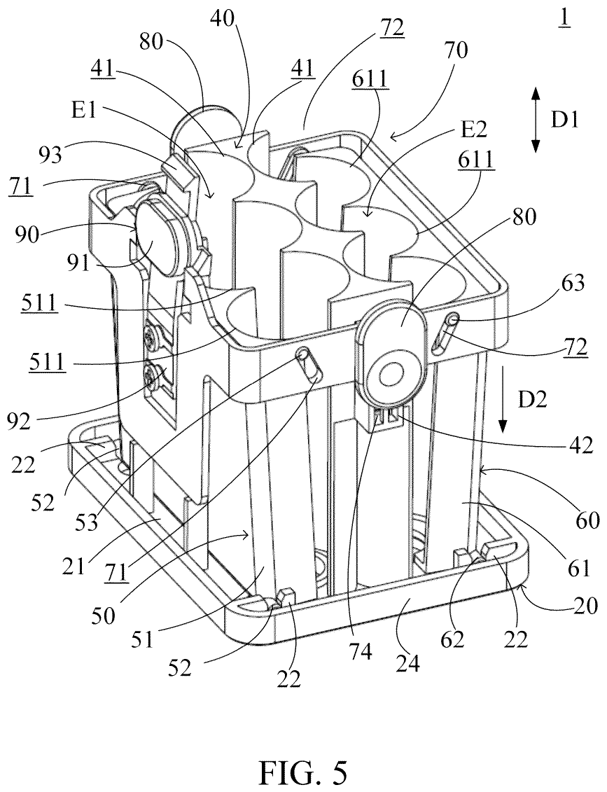

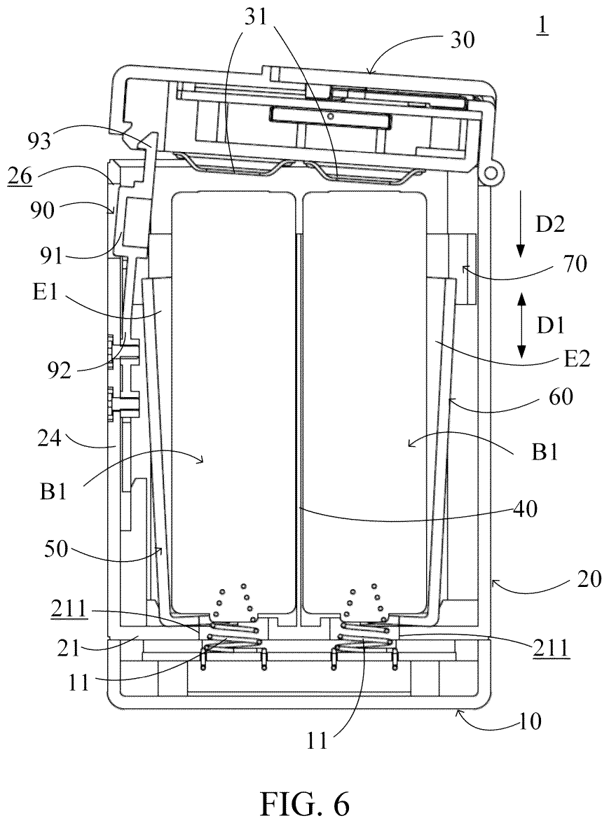

FIG. 5 is a partial perspective view of the battery box 1 shown in FIG. 4, wherein the battery box 1 is in a releasing state. FIG. 6 is a cross-sectional view of the battery box 1 shown in FIG. 1, wherein the battery box 1 is in the releasing state. As shown in FIG. 4, if the batteries B1 located inside battery box 1 are swollen, the batteries B1 will be difficult to be removed from the battery box 1.

As shown in FIG. 4 to FIG. 6, the user can move the releasing button 80 on the side wall 24 of the housing 20 from the initial position to a releasing position in the opening direction D2. When the releasing button 80 moves the driving element 70 in the opening direction D2, the first driving portion 53 moves from the bottom of the first guiding groove 71 in FIG. 3 to the top of the first guiding groove 71 in FIG. 4, so as to rotate the first restriction element 50 relative to the bottom plate 21 and increase the distance between the top of the first restriction element 50 and the partition element 40. In addition, the second driving portion 63 moves from the bottom of the second guiding groove 72 in FIG. 3 to the top of the second guiding groove 72 in FIG. 4 to rotate the second restriction element 60 relative to the bottom plate 21, and increase the distance between the top of the second restriction element 60 and the partition element 40. In other words, the volumes of the first battery groove E1 and the second battery groove E2 are increased, so swollen batteries B1 (as shown in FIG. 4) in the first battery groove E1 and the second battery groove E2 can be easily taken out from the battery box 1.

As shown in FIG. 4 to FIG. 6, when the driving element 70 is moved in the opening direction D2, and the opening button 90 is pressed, the opening button 90 releases the cover 30, and the volumes of the first battery groove E1 and the second battery groove E2 are increased. At this time, the batteries B1 can be pushed by the first elastic electrodes 11, so that the batteries B1 push the cover 30 to be opened relative to the housing 20.

In the present disclosure, the battery box 1 increases the volume of the battery groove by rotating the first restriction element 50 and the second restriction element 60 through the driving element 70, so that swollen batteries can be easily taken out of the battery box 1.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A battery box, comprising:
a housing comprising a bottom plate, and a first pivoting base disposed on the bottom plate;
a partition element in the housing, and disposed on the bottom plate;
a first restriction element pivoted on the first pivoting base, wherein a first battery groove is formed between the first restriction element and the partition element; and
a driving element disposed on the first restriction element,
wherein when the driving element is moved, the first restriction element is rotated relative to the bottom plate, and a distance between a top of the first restriction element and a top of the partition element is increased.

2. The battery box as claimed in claim 1, wherein the first restriction element comprises:
a first restriction body in the housing; and
a first rotation shaft disposed on a bottom of the first restriction body, and pivoted on the first pivoting base.

3. The battery box as claimed in claim 1, wherein the driving element further comprises a first guiding groove, and the first restriction element further comprises a first driving portion in the first guiding groove,
wherein when the driving element is moved in an opening direction, the first driving portion is moved from a bottom end of the first guiding groove to a top end of the first guiding groove, and the first guiding groove is inclined relative to the opening direction.

4. The battery box as claimed in claim 1, wherein the housing further comprises a second pivoting base disposed on the bottom plate, and the battery box further comprises:
a second restriction element pivoted on the second pivoting base, and a second battery groove between the second restriction element and the partition element,
wherein the driving element is disposed on the second restriction element,
when the driving element is moved in an opening direction, the second restriction element is rotated relative to the bottom plate, and a distance between a top of the second restriction element and the top of the partition element is increased.

5. The battery box as claimed in claim 4, wherein the partition element is between the first restriction element and the second restriction element,
wherein when the driving element is moved in the opening direction, the top of first restriction element and the top of the second restriction element are moved in opposite directions.

6. The battery box as claimed in claim 4, wherein the driving element surrounds the top of the first restriction element, the top of the second restriction element, and the top of the partition element.

7. The battery box as claimed in claim 4, wherein the second restriction element comprises:
a second restriction body in the housing; and
a second rotation shaft disposed on a bottom of the second restriction body, and pivoted on the second pivoting base.

8. The battery box as claimed in claim 4, wherein the driving element further comprises a second guiding groove, and the second restriction element further comprises a second driving portion in the second guiding groove,
wherein when the driving element is moved in the opening direction, the second driving portion is moved from a bottom end of the second guiding groove to a top end of the second guiding groove, and the second guiding groove is inclined relative to the opening direction.

9. The battery box as claimed in claim 4, wherein the partition element further comprises a main receiving groove, the first restriction element further comprises a first receiving groove, and the second restriction element further comprises a second receiving groove,
wherein the first battery groove is formed between the main receiving groove and the first receiving groove, and the second battery groove is formed between the main receiving groove and the second receiving groove.

10. The battery box as claimed in claim 1, further comprising a releasing button movably disposed on the housing,
wherein the driving element further comprises a limitation block, and the releasing button is connected to the limitation block via a limitation hole of the housing.

11. The battery box as claimed in claim 10, wherein the partition element further comprises a blocking portion, the driving element further comprises an elastic element, abutting the blocking portion and the limitation hole, the elastic element is configured to maintain the driving element in an initial position.

12. The battery box as claimed in claim 1, further comprising:
a cover pivoted on the housing; and
an opening button disposed on the housing and locking the cover.

13. The battery box as claimed in claim 12, wherein the cover further comprises a front opening, and the opening button comprises:
a button body disposed in the housing, and exposed form the front opening;
an elastic arm connected to the button body, and an end of the elastic arm affixed to the housing; and
a hook, connected to the button body, and locking the cover.

14. The battery box as claimed in claim 12, further comprising:
a base affixed to the housing, and comprising a first elastic electrode,
wherein the first elastic electrode extends through the bottom plate.

15. The battery box as claimed in claim 14, wherein the cover comprises a second elastic electrode, wherein a battery is placed in the first battery groove, and contacts the first elastic electrode and the second elastic electrode,
when the driving element is moved in an opening direction, and the opening button is pressed, the battery is pushed by the first elastic electrode to make the cover opening relative to the housing.
